(19) United States
(12) Patent Application Publication
(10) Pub. No.: US 2024/0160887 A1
(43) Pub. Date: May 16, 2024

(54) RADIO FREQUENCY INTEGRATED CIRCUIT (RFIC) SELECTION

(71) Applicant: QUALCOMM Incorporated, San Diego, CA (US)

(72) Inventors: Jun Zhu, San Diego, CA (US); Mihir Vijay Laghate, San Diego, CA (US); Mahbod Ghelichi, San Diego, CA (US); James Francis Geekie, Carlsbad, CA (US); Jittra Jootar, San Diego, CA (US); Raghu Narayan Challa, San Diego, CA (US)

(21) Appl. No.: 18/055,256

(22) Filed: Nov. 14, 2022

(51) Int. Cl. G06K 19/077; G06K 19/07

(52) U.S. Cl. CPC G06K 19/07775; G06K 19/0717

(57) ABSTRACT

This disclosure provides systems, methods, and devices for wireless communication that support radio frequency integrated circuit (RFIC) selection. In a first aspect, a method of wireless communication includes, for each RFIC of a plurality of RFICs, determining a status of the RFIC based on a temperature associated with the RFIC. The method further includes selecting an RFIC of the plurality of RFICs based on the plurality of status, and wirelessly communicating data using the selected RFIC. Other aspects and features are also claimed and described.

### TECHNICAL FIELD

Aspects of the present disclosure relate generally to wireless communication systems, and more particularly, to radio frequency integrated circuit (RFIC) selection, such as thermal-aware RFIC selection for 5G new radio (NR) millimeter wave (mmW). Some features may enable and provide improved communications, efficient resource utilization, improved network access, reduced device damage, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

UEs or other wireless communication devices configured to operate in millimeter wave (mmW) frequency bands may utilize radio frequency (RF) transceivers to achieve beamforming for communication at high 5G data rates. Such RF transceivers typically have high power consumption requirements which may cause thermal issues during sustained high data rate use cases, such as a video call. To address a thermal issue of an RF transceiver, a device may the number of active antenna elements on a RF integrated circuit (RFIC), which may cause the device to have to switch to another RFIC (that is not thermal limited) that can support a greater number of active antennas elements, and thus higher data rates. However, in situations where the device is operating with throughput-constrained beam management (TCB) where the device adaptively selects its number of active antenna elements to meet the throughput target, the device may still stay at a heated RFIC even if the number of active antenna elements gets very low.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a user equipment (UE). The method includes, for each radio frequency integrated circuit (RFIC) of a plurality of RFICs, determining a status of the RFIC based on a temperature associated with the RFIC. The method also includes selecting an RFIC of the plurality of RFICs based on the plurality of status, wirelessly communicating data using the selected RFIC.

In an additional aspect of the disclosure, an apparatus includes a plurality of RFICs, at least one processor, and a memory coupled to the at least one processor. Each RFIC of the plurality of RFICs configured for wireless communication. The at least one processor is configured to, determine a status of the RFIC based on a temperature associated with the RFIC. The at least one processor is further configured to select, based on the plurality of status, an RFIC of the plurality of RFICs for wireless communication of data.

In an additional aspect of the disclosure, an apparatus includes means for determining, for each RFIC of a plurality of RFICs, a status of the RFIC based on a temperature associated with the RFIC. The apparatus further includes means for selecting an RFIC of the plurality of RFICs based on the plurality of status, and means for wirelessly communicating data using the selected RFIC.

In an additional aspect of the disclosure, a non-transitory computer-readable medium stores instructions that, when executed by a processor, cause the processor to perform operations. The operations include, for each RFIC of a plurality of RFICs, determining a status of the RFIC based on a temperature associated with the RFIC. The operations further include selecting an RFIC of the plurality of RFICs based on the plurality of status, and wirelessly communicating data using the selected RFIC.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports radio frequency integrated circuit (RFIC) selection according to one or more aspects.

FIG. 4 is a flow diagram illustrating an example process that supports RFIC selection according to one or more aspects.

FIG. 5 is a block diagram of an example UE that supports RFIC selection according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support radio frequency integrated circuit (RFIC) selection. For example, the present disclosure describes section of an RFIC of a plurality of RFICs. To illustrate, a device, such as a user equipment (UE) or a modem, may select the RFIC based on a temperature, such as a junction temperature. The device may determine, for each of one or more RFICs of the plurality of RFICs, a temperature and determine a status of the RFIC based on the temperature. For example, the device may compare the temperature to a threshold and, if the temperature is greater than or equal to the threshold, set a status of the RFIC to a first status (e.g., non-preferred). Alternatively, if the temperature is less than the threshold, the status may be set to a second status (e.g. preferred). Additionally, or alternatively, the device may determine the status of at least one RFIC of the plurality of RFICs based on a change in temperature of the at least one RFIC. If the rate of change is greater than or equal to a threshold, the status of the at least one RFIC is set to a first status, otherwise the status is set to the second status. The device may select an RFIC having the first status for use in wireless communications. In some implementations, the device may select an RFIC that has an available throughput that is greater than or equal to a throughput target.

Particular implementations of the subject matter described in this disclosure may be implemented to realize one or more of the following potential advantages or benefits. In some aspects, the present disclosure provides techniques for supporting RFIC selection. The techniques described may enable a device, such as a UE, to perform an uplink data transfer at a high transmit power. For example, the device may perform a 5G data call and may use a beam formed using a selected RFIC to transfer data. The device may not be aware of the position of one or more RFICs within the device or a position relative to one or more other components within the device, such as a position proximate to or near a camera which may heat an RFIC during a video call. Using the techniques described herein, the device may advantageously select an RFIC based on a temperature (e.g., Tj) of a temperature sample or a change in temperature (e.g., a change in Tj) based on consecutive temperature samples.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RAT s) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., −0.99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

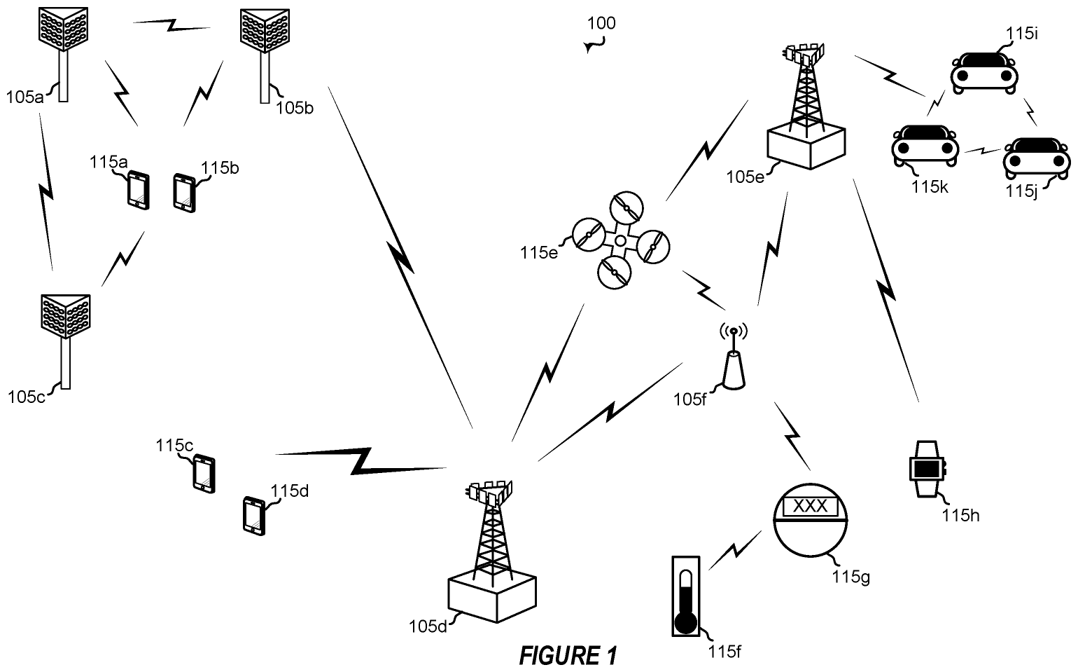

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with a core network and with one another. For example, base stations 105 may interface with the core network through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via the core network).

The core network may provide user authentication, access authorization, tracking, Internet Protocol (IP) connectivity, and other access, routing, or mobility functions. The core network may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, the core network includes or is coupled to a Location Management Function (LMF), which is an entity in the 5G Core Network (5GC) supporting various functionality, such as managing support for different location services for one or more UEs. For example the LMF may include one or more servers, such as multiple distributed servers. Base stations 105 may forward location messages to the LMF and may communicate with the LMF via a NR Positioning Protocol A (NRPPa). The LMF is configured to control the positioning parameters for UEs 115 and the LMF can provide information to the base stations 105 and UE 115 so that action can be taken at UE 115. In some implementations, UE 115 and base station 105 are configured to communicate with the LMF via an Access and Mobility Management Function (AMF).

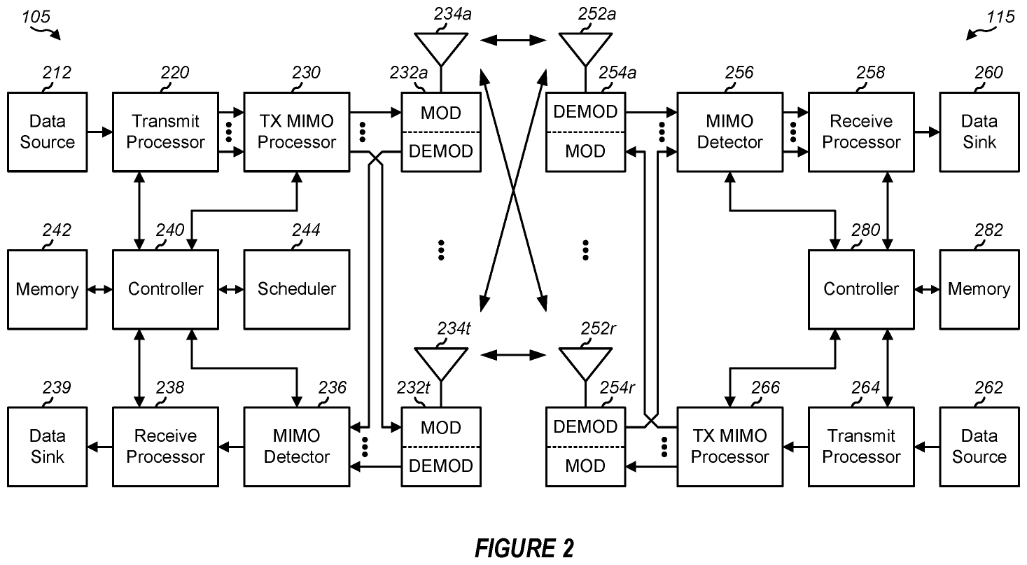

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

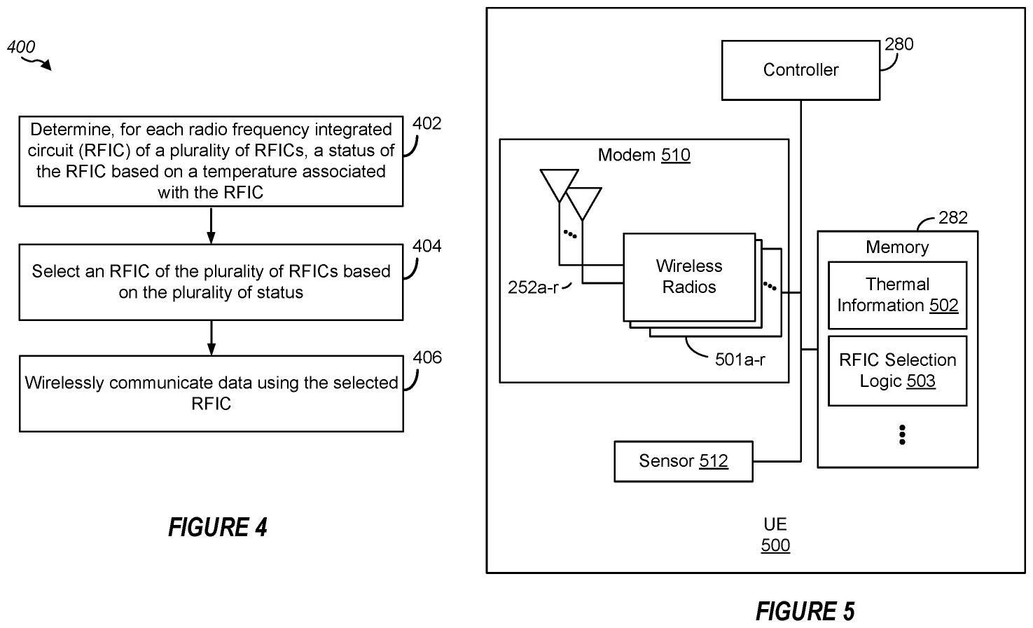

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 4, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

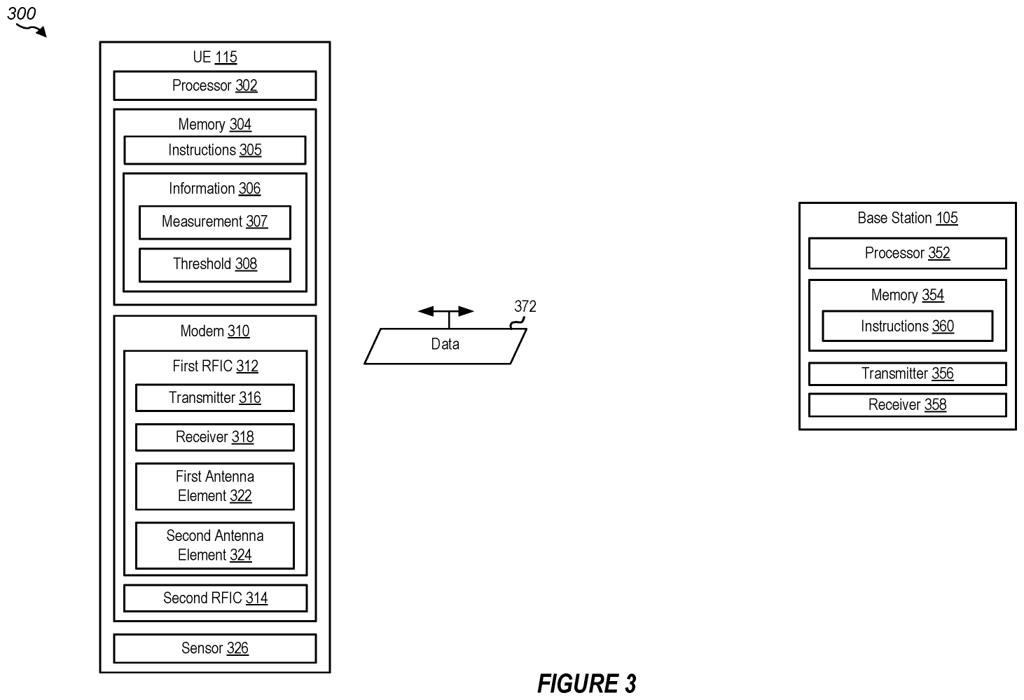

FIG. 3 is a block diagram of an example wireless communications system 300 that supports RFIC selection according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, multiple base station 105, or a combination thereof.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), a modem 310, and a sensor. Processor 302 may be configured to execute instructions 305 stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store instructions 305 and information 306. Information 306 may include one or more measurements 307 (hereinafter referred to collectively as “measurement 307”) and one or more thresholds 308 (hereinafter referred to collectively as “threshold 308”). Measurement 307 may include or indicate measurement information or measurement data, such as data associated with or corresponding to a temperature of an RFIC. In some implementations, the temperature of the RFIC is a junction temperature (Tj) of the RFIC. Threshold 308 may include or indicate a temperature threshold, a temperature increase rate, a wireless communication throughput threshold (e.g., a data rate threshold), or a combination thereof, as illustrative, non-limiting examples.

Modem 310 includes multiple RFICs, such as a first RFIC 312 and a second RFIC 314. Although described as including two RFICs, in other implementations, modem 310 include more than two RFICs. Second RFIC 314 may include one or more components, perform one or more operation, or a combination thereof, as described herein with reference to first RFIC 312.

First RFIC 312 includes one or more transmitters 316 (hereinafter referred to collectively as “transmitter 316”), one or more receivers 318 (hereinafter referred to collectively as “receiver 318”), and one or more antenna arrays. Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2. In some implementations, UE 115 may include an interface (e.g., a communication interface) that includes transmitter 316, receiver 318, or a combination thereof. Although transmitter 316 and receive 318 are described as separate components, in other implementations, transmitter 316 and receiver 318 may be included in a transceiver, such as a transceiver included first RFIC 312.

The one or more antenna arrays may include one or more antenna elements. The one or more antenna arrays may be coupled to transmitter 316, receiver 318, or a communication interface. The antenna array may include one or more antenna elements configured to perform wireless communications with other devices, such as with the base station 105. For example, the one or more antenna elements may include a first antenna element 322 and a second antenna element 324. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Sensor 326 is configured to measure (or sample) one or more parameters associated with modem 310, first RFIC 312, second RFIC 314, or a combination there. While the sensor 326 is in an active state, sensor 326 may be configured to measure the one or more parameters continuously, periodically, randomly, or a combination thereof. In some implementations, the one or more parameters may include or indicate a temperature, such as a junction temperature (Tj). In some implementations, sensor 326 includes a thermocouple configured to directly measure a temperature, such as a junction temperature. In other implementations, sensor 326 is configured indirectly measure the one or more parameters, such a voltage/temperature dependency characteristic. In some such implementations, modem 310 or processor 302 may be configured to use the one or more parameters and perform a Joint Electron Device Engineering Council (JEDEC) technique, such as JESD 51-1 and JESD 51-51, to determine a Tj measurement.

UE 105 may include one or more components as described herein with reference to UE 115. In some implementations, UE 105 is a 5G-capable UE, a 6G-capable UE, or a combination thereof.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). In some implementations, base station 105 may include an interface (e.g., a communication interface) that includes transmitter 356, receiver 358, or a combination thereof. Memory 354 includes or is configured to store instructions 360. Processor 352 may be configured to execute instructions 360 stored in memory 354 to perform the operations described herein. In some implementations, processor 352 includes or corresponds to one or more of receive processor 238, transmit processor 220, and controller 240, and memory 354 includes or corresponds to memory 242.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, base station 105 may include one or more antenna arrays. The antenna array may include multiple antenna elements configured to perform wireless communications with other devices, such as with the UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 300 implements a 6G network.

In some implementations, UE 115 configured to select an RFIC of multiple RFICs. For example, UE 115 may select the RFIC based on a temperature associated with the multiple RFICs and may communicate data using the selected RFIC. To illustrate, UE 115 may be configured to determine a temperature for each RFIC of the multiple RFICs and may select the RFIC based on the determined temperatures. The temperature may be a junction temperature (Tj). In some implementations, UE 115 is configured to track a temperature of at least one RFIC of the multiple RFICs. For example, UE 115 may determine consecutive temperatures associated with the at least one RFIC during a time period. UE 115 may also track a temperature of each RFIC of the multiple RFICs.

UE 115 select an RFIC of multiple RFICs based on a status of each RFIC, such as a status determined by UE 115. For example, the status may be determined as a first status (e.g., a preferred status) or a second status (e.g., a nonpreferred status). UE 115 may determine a status of an RFIC based on a single temperate, multiple temperatures, a change in temperature over one or more time periods, or a combination thereof. To illustrate, for at least one RFIC of the multiple RFICs, UE 115 may determine a temperature associated with the at least one RFIC and compare the temperature to a first threshold (e.g., 308). If the temperature is greater than or equal to the first threshold, UE 115 may determine the status of the at least one RFIC is the second status. Alternatively, if the temperature is less than the first threshold, UE 115 may determine the status of the at least one RFIC as the first status.

In some implementations, UE 115 may determine or update the status of the at least one RFIC based on a determination that a number of temperature samples during a time period are greater than or equal to a third threshold number (e.g., 308). For example, UE 115 may set the status of the at least one RFIC to the second status based on a determination that ten or more temperature samples of the at least one RFIC are greater than the third threshold number during a time period. In some implementations, the number of temperature samples that are greater than or equal to the third threshold number need to be consecutive temperature samples for UE 115 to determine or update the status.

In some implementations, after the status of the RFIC is set to the first status, UE 115 may update the status from the second status to the first status based on a temperature of the at least one RFIC being less that or equal to a second threshold (e.g., 308). The second threshold may be the same as or different from the first threshold. For example, the second threshold may be less than the first threshold.

In some implementations, UE 115 may determine the status of the at least one RFIC based on a change, such as a slope or rate of change) of the temperature of the at least one RFIC. To illustrate, UE 115 may determine two or more consecutive temperature samples of or associated with the at least one RFIC. For at least one pair of temperature samples of the two or more consecutive temperature samples, UE 115 may determine a change in temperature between a first temperature sample of the pair of temperature samples and a second temperature sample of the pair of temperature samples. The pair of temperature samples may include a pair of consecutive temperature samples or a pair of any two temperature samples, such as first and last temperature sample (during a time period). UE 115 may compare the change of the pair of temperature samples to a fourth threshold (e.g., 308). If the change is greater than or equal to the fourth threshold, UE 115 may determine the status of the at least one RFIC is the second status. Alternatively, if the temperature is less than the fourth threshold, UE 115 may determine the status of the at least one RFIC as the first status.

In some implementations, UE 115 may determine a change for each of multiple pairs of temperature samples of three or more temperature samples associated with the at least one RFIC. For each pair of temperature samples, UE 115 may compare the change to the fourth threshold. UE 115 may change the status of the at least one RFIC based on a determination that a number (e.g., a first predetermined number) of changes are greater than or equal to the fourth threshold during a time period or out of a number (e.g., a second predetermined number that is the same as or different from the first predetermined number) of determined changes. Additionally, or alternatively, UE 115 may change the status of the at least one RFIC based on a number of consecutive determined changes being greater than or equal to the fourth threshold.

In some implementations, after the status of the RFIC is set to the first status, UE 115 may update the status from the second status to the first status based on a temperature of the at least one RFIC being less than or equal to the second threshold (e.g., 308).

UE 115 may select an RFIC having the first status for use in wireless communication. For example, UE 115 may perform wireless communication based on a beam formed using the selected RFIC having the first status. If multiple RFICs are available having the first status, UE 115 may select the RFIC for use randomly, based on a temperature (e.g., a lowest temperature or lowest average temperature over a time period or number of temperature samples), an available throughput, another metric, or combination thereof. In some implementations, UE 115 may select an RFIC having the first status and that is determined to have an available throughput that is greater than or equal to a throughput target. If no RFICs having the first status and an available throughput that is greater than or equal to the throughput target, UE 115 may select an RFIC that has an available throughput that is greater than or equal to the throughput target. For example, UE 115 may select an RFIC having the second status. If multiple RFICs have an available throughput that is greater than or equal to the throughput target, UE 115 may select one of the multiple RFICs randomly, based on a temperature (e.g., a lowest temperature or lowest average temperature over a time period or number of temperature samples), an available throughput, another metric, or combination thereof.

During operation of wireless communications system 300, UE 115 configured to select an RFIC of a plurality of RFICs, such as first RFIC 312 and second RFIC 314. To illustrate, to select an RFIC, UE 115 may, for each of one or more RFICs of the plurality of RFICs, determine a temperature, such as a junction temperature, of or associated with the RFIC. For example, UE 115 may determine the temperature based on information (e.g., 306 or 307) or data received from sensor 326. Additionally, or alternatively, UE 115 may, for each of one or more RFICs of the plurality of RFICs, determine a status of the RFIC based on the temperature of or associated with the RFIC. For each RFIC of the plurality of RFICs, the status may be determined from a set of status including a preferred status or a non-preferred status. UE 115 may select an RFIC of the plurality of RFICs for use based on one or more determined status. UE 115 may wirelessly communicate data 372 using the selected RFIC. For example, UE 115 may communicates data 372 with base station 105 such that UE 115 transmits data 372 to base station 105 or receives data 372 from base station 105.

In some implementations, for each determined temperature, UE 115 may compare the temperature to a threshold, such as threshold 308. To illustrate, UE 115 may perform a comparison based on the temperature of the RFIC and a threshold. UE 115 may determine the status based on the comparison—e.g., a result of the comparison.

In some implementations, UE 115 may, for each of one or more RFICs of the plurality of RFICs, determine the status of the RFIC based on a change in temperature of or associated with the RFIC. To illustrate, UE 115 may determine a plurality of consecutive temperatures associated with the RFIC. In some implementations, the plurality of consecutive temperatures includes multiple pairs of consecutive temperatures, is measured during a time period, or a combination thereof. For each pair of consecutive temperatures of the plurality of consecutive temperatures, UE 115 may determine a change in temperature, and perform a comparison based on the change in temperature and a threshold (e.g., 308). In some implementations, for each pair of consecutive temperatures of the plurality of consecutive temperatures, a result of the comparison indicates whether the change in temperature is greater than or equal to the threshold. UE 115 may determine the status based on the comparison for each pair of the consecutive temperatures of the plurality of consecutive temperature. In some implementations, UE 115 may determine the status based on whether a result of the comparison for each pair of the consecutive temperatures of the plurality of consecutive temperatures indicates that the change in temperature is greater than or equal to the threshold.

In some implementations, UE 115 may determine a first set of RFIC having a first status, such as a preferred status. For each RFIC of the first set of RFICs, UE 115 may determine whether the RFIC is available based on a throughput target. To illustrate, UE 115 may perform a compassion based on an available throughput of the RFIC and the throughput target. If the available throughput is greater than or equal to the target throughput, the RFIC may be available for selection.

In some implementations, one or more operations described herein that are performed by UE 115 may be performed by or using processor 302. Additionally, or alternatively, one or more operations described herein that are performed by UE 115 may be performed by or using modem 310.

As described with reference to FIG. 3, the present disclosure provides techniques for supporting RFIC selection. The techniques described may enable and provide improved communications, efficient resource utilization, improved network access, reduced device damage, or a combination thereof. To illustrate, the techniques described herein may enable a device, such as UE 115, to perform an uplink data transfer at a high UE transmit power. For example, UE 115 may perform a 5G data call and may use a beam formed using a selected RFIC to transfer data, such as data 372. UE 115 (or modem 310) may not be aware of the position of one or more RFICs within UE 115 or a position relative to one or more other components within UE 115, such as a position proximate to or near a camera which may heat an RFIC during a video call. Using the techniques described herein, UE 115 (or modem 310) may determine a temperature (e.g., Tj) of a temperature sample or a change in temperature (e.g., a change in Tj) based on consecutive temperature samples. Accordingly, UE 115 (or modem 310) may advantageously select an RFIC based on a temperature (e.g., Tj) of a temperature sample or a change in temperature (e.g., a change in Tj) based on consecutive temperature samples.

FIG. 4 is a flow diagram illustrating an example process 400 that supports RFIC selection according to one or more aspects. Operations of process 400 may be performed by a UE, such as UE 115 described above with reference to FIGS. 1-3 or a UE described with reference to FIG. 5. For example, example operations (also referred to as “blocks”) of process 400 may enable UE 115 to support RFIC selection. Additionally, or alternatively, operations of process 400 may be performed by a wireless communication device or a component thereof, such as a modem.

In block 402, the UE determines, for each RFIC of a plurality of RFICs, a status of the RFIC based on a temperature associated with the RFIC. The temperature may include or correspond to measurement 307. In some implementations, the temperature is a junction temperature. The plurality of RFICs may include or correspond to modem 310, first RFIC 312, second RFIC 314, or a combination thereof. Each RFIC of the plurality of RFICs configured for wireless communication. Additionally, or alternatively, each RFIC of the plurality of RFICs includes one or more transceivers, one or more antenna elements, or a combination thereof. For each RFIC of the plurality of RFICs, the status may be determined from a set of status including a preferred status or a non-preferred status. In some implementations, for each RFIC of the plurality of RFICs, the UE determines the temperature of the RFIC.

In block 404, the UE selects an RFIC of the plurality of RFICs based on the plurality of status. In block 406, the UE wirelessly communicates data using the selected RFIC. For example, the data may include or correspond to data 372.

In some implementations, to determine the status of the RFIC the UE may perform a comparison based on the temperature of the RFIC and a threshold. For example, the threshold may include or correspond to threshold 308. In some such implementations, the status is determined based on the comparison.

In some implementations, the UE determines, for each RFIC of the plurality of RFICs, a plurality of consecutive temperatures associated with the RFIC. The plurality of consecutive temperatures may include multiple pairs of consecutive temperatures, is measured during a time period, or a combination thereof. For each pair of consecutive temperatures of the plurality of consecutive temperatures, the UE may determine a change in temperature. Additionally, for each pair of consecutive temperatures of the plurality of consecutive temperatures, the UE may perform a comparison based on the change in temperature and a threshold. The threshold may include or correspond to threshold 308. The status may be determined based on the comparison for each pair of the consecutive temperatures of the plurality of consecutive temperatures. In some implementations, for each pair of consecutive temperatures of the plurality of consecutive temperatures, a result of the comparison indicates whether the change in temperature is greater than or equal to the threshold. The status may be determined based on whether a result of the comparison for each pair of the consecutive temperatures of the plurality of consecutive temperatures indicates that the change in temperature is greater than or equal to the threshold.

In some implementations, the UE determines a first set of RFIC having a first status. The first RFIC may include or correspond to first RFIC 312. For each RFIC of the first set of RFICs, the UE may determine whether the RFIC is available based on a throughput target. In some such implementations, the RFIC of the plurality of RFICs is included in the first set of RFICs and selected from the first set of RFICs based on a determination that the RFIC is available.

FIG. 5 is a block diagram of an example UE 500 that supports RFIC selection according to one or more aspects. UE 500 may be configured to perform operations, including the blocks of a process described with reference to FIG. 4. In some implementations, UE 500 includes the structure, hardware, and components shown and described with reference to UE 115 of FIGS. 1-3. For example, UE 500 includes controller 280, which operates to execute logic or computer instructions stored in memory 282, as well as controlling the components of UE 500 that provide the features and functionality of UE 500. UE 500, under control of controller 280, transmits and receives signals via wireless radios 501a-r and antennas 252a-r. Wireless radios 501a-r include various components and hardware, as illustrated in FIG. 2 for UE 115, including modulator and demodulators 254a-r, MIMO detector 256, receive processor 258, transmit processor 264, and TX MIMO processor 266. In some implementations, one or more wireless radios are included in the same RFIC, such as first RFIC 312 or second RFIC 314. UE 500 also includes a sensor 512. Sensor 512 may include or correspond to sensor 326.

In some implementations UE 600 includes a modem 510. Modem 510 may include or correspond to modem 310. Modem 510 may include wireless radios 501a-r, antennas 252a-r, one or more RFICs, or a combination thereof. Additionally, although modem 510 is shown as being separate from controller 280, memory 282, and sensor 512, in other implementations, modem 510 may include controller 280, memory 282, sensor 512, or a combination thereof.

As shown, memory 282 may include thermal information 502 and communication logic 503. Thermal information 602 may include or correspond to measurement 307. Communication logic 503 may be configured to enable communication between UE 500 and one or more other devices. Additionally, or alternatively, communication logic 503 may be configured to enable selection of a wireless radio of wireless radios 501a-r. UE UE 500 may receive signals from or transmit signals to one or more network entities, such as base station 105 of FIGS. 1-3.

It is noted that one or more blocks (or operations) described with reference to FIG. 4 may be combined with one or more blocks (or operations) described with reference to another of the figures. For example, one or more blocks (or operations) of FIG. 4 may be combined with one or more blocks (or operations) associated with FIG. 5. As another example, one or more blocks associated with FIG. 4 may be combined with one or more blocks (or operations) associated with FIGS. 1-3. Additionally, or alternatively, one or more operations described above with reference to FIGS. 1-3 may be combined with one or more operations described with reference to FIG. 5.

In one or more aspects, techniques for supporting RFIC selection may include additional aspects, such as any single aspect or any combination of aspects described below or in connection with one or more other processes or devices described elsewhere herein. In a first aspect, techniques for supporting RFIC selection may include for each RFIC of a plurality of RFICs, determining a status of the RFIC based on a temperature associated with the RFIC. The techniques may further include selecting an RFIC of the plurality of RFICs based on the plurality of status, and wirelessly communicating data using the selected RFIC. In some examples, the techniques in the first aspect may be implemented in a method or process. In some other examples, the techniques of the first aspect may be implemented in a wireless communication device, which may include a UE, a component of a UE (e.g., a modem), another device, or a component of the other device. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the techniques further include, for each RFIC of the plurality of RFICs, determining the temperature of the RFIC.

In a third aspect, in combination with the first aspect or the second aspect, for each RFIC of the plurality of RFICs, the status is determined from a set of status including a preferred status or a non-preferred status.

In a fourth aspect, in combination with one or more of the first aspect through the third aspect, the temperature is a junction temperature of the RFIC.

In a fifth aspect in combination with one or more of the first aspect through the fourth aspect, to determine the status of the RFIC, the techniques further include, for each RFIC performing a comparison based on the temperature of the RFIC and a threshold.

In a sixth aspect, in combination with the fifth aspect, the status is determined based on the comparison.

In a seventh aspect, in combination with one or more of the first aspect through the sixth aspect, the techniques further include determining a plurality of consecutive temperatures associated with the RFIC.

In an eighth aspect, in combination with the seventh aspect, the techniques further include, for each pair of consecutive temperatures of the plurality of consecutive temperatures, determining a change in temperature.

In a ninth aspect, in combination with the eighth aspect, the techniques further include, for each pair of consecutive temperatures of the plurality of consecutive temperatures, performing a comparison based on the change in temperature and a threshold.

In a tenth aspect, in combination with the ninth aspect, the status is determined based on the comparison for each pair of the consecutive temperatures of the plurality of consecutive temperatures.

In an eleventh aspect, in combination with the tenth aspect, for each pair of consecutive temperatures of the plurality of consecutive temperatures, a result of the comparison indicates whether the change in temperature is greater than or equal to the threshold.

In a twelfth aspect, in combination with the tenth aspect or the eleventh aspect, the plurality of consecutive temperatures includes multiple pairs of consecutive temperatures, is measured during a time period, or a combination thereof.

In a thirteenth aspect, in combination with one or more of the tenth aspect through the twelfth aspect, the status is determined based on whether a result of the comparison for each pair of the consecutive temperatures of the plurality of consecutive temperatures indicates that the change in temperature is greater than or equal to the threshold.

In a fourteenth aspect, in combination with the thirteenth aspect, the techniques further include determining a first set of RFIC having a first status.

In a fifteenth aspect, in combination with the fourteenth aspect, the techniques further include, for each RFIC of the first set of RFICs, determining whether the RFIC is available based on a throughput target.

In a sixteenth aspect, in combination with the sixteenth aspect, the RFIC of the plurality of RFICs is included in the first set of RFICs.

In a seventeenth aspect, in combination with the sixteenth aspect, the RFIC of the plurality of RFICs is selected from the first set of RFICs based on a determination that the RFIC is available.

In an eighteenth aspect, in combination with one or more of the fourteenth aspect through the seventeenth aspect, the first status is a preferred status.

In a nineteenth aspect, in combination with one or more of the first aspect through the eighteenth aspect, the techniques further include determining a second set of RFIC having a second status. In some implementations, the second status is a nonpreferred status.

In a twentieth aspect, in combination with the nineteenth aspect, the techniques further include, for each RFIC of the second set of RFICs, determining whether the RFIC is available based on a throughput target.

In a twenty-first aspect, in combination with one or more of the fifteenth aspect through the twentieth aspect, the throughput target is a minimum data rate.

In a twenty-second aspect, in combination with one or more of the first aspect through the twenty-first aspect, the techniques further include determining a throughput target.

In a twenty-third aspect, in combination with one or more of the first aspect through the twenty-second aspect, for each RFIC of the plurality of RFICs, the status of the RFIC is further determined based on a maximum throughput capability of the RFIC, a throughput of the RFIC, a throughput target, or a combination thereof.

In a twenty-fourth aspect, in combination with one or more of the first aspect through the twenty-third aspect, each RFIC of the plurality of RFICs includes one or more RF transceivers configured to perform beamforming, operate in mmW frequency bands, or a combination thereof.

In a twenty-fifth aspect, in combination with one or more of the first aspect through the twenty-fourth aspect, each RFIC of the plurality of RFICs includes one or more antenna elements.

In a twenty-sixth aspect, in combination with one or more of the first aspect through the twenty-fifth aspect, each RFIC of the plurality of RFICs configured for wireless communication.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
for each radio frequency integrated circuit (RFIC) of a plurality of RFICs, determining a status of the RFIC based on a temperature associated with the RFIC;
selecting an RFIC of the plurality of RFICs based on the plurality of status; and
wirelessly communicating data using the selected RFIC.

2. The method of claim 1, further comprising:
for each RFIC of the plurality of RFICs, determining the temperature of the RFIC, and
wherein, for each RFIC of the plurality of RFICs, the status is determined from a set of status including a preferred status or a non-preferred status.

3. The method of claim 1, wherein the temperature is a junction temperature of the RFIC.

4. The method of claim 1, wherein:
for each RFIC of the plurality of RFICs, determining the status of the RFIC includes performing a comparison based on the temperature of the RFIC and a threshold, and
the status is determined based on the comparison.

5. The method of claim 1, further comprising:
determining a plurality of consecutive temperatures associated with the RFIC; and
for each pair of consecutive temperatures of the plurality of consecutive temperatures:
determining a change in temperature; and
performing a comparison based on the change in temperature and a threshold; and
wherein the status is determined based on the comparison for each pair of the consecutive temperatures of the plurality of consecutive temperatures.

6. The method of claim 5, wherein, for each pair of consecutive temperatures of the plurality of consecutive temperatures, a result of the comparison indicates whether the change in temperature is greater than or equal to the threshold.

7. The method of claim 5, wherein:
the plurality of consecutive temperatures includes multiple pairs of consecutive temperatures, is measured during a time period, or a combination thereof, and
the status is determined based on whether a result of the comparison for each pair of the consecutive temperatures of the plurality of consecutive temperatures indicates that the change in temperature is greater than or equal to the threshold.

8. The method of claim 1, further comprising:
determining a first set of RFIC having a first status; and
for each RFIC of the first set of RFICs, determining whether the RFIC is available based on a throughput target, and
wherein the RFIC of the plurality of RFICs is included in the first set of RFICs and selected from the first set of RFICs based on a determination that the RFIC is available.

9. A user equipment (UE) comprising:
a plurality of radio frequency integrated circuits (RFICs), each RFIC of the plurality of RFICs configured for wireless communication;
a memory storing processor-readable code; and
at least one processor coupled to the memory, the at least one processor configured to execute the processor-readable code to cause the at least one processor to:
for each RFIC of the plurality of RFICs, determine a status of the RFIC based on a temperature associated with the RFIC; and
select, based on the plurality of status, an RFIC of the plurality of RFICs for wireless communication of data.

10. The UE of claim 9, wherein each RFIC of the plurality of RFICs includes one or more transceivers, one or more antenna elements, or a combination thereof.

11. The UE of claim 9, further comprising a modem including the plurality of RFICs.

12. The UE of claim 9, wherein:
the at least one processor is configured to execute the processor-readable code to cause the at least one processor to, for each RFIC of the plurality of RFICs, determine the temperature of the RFIC, and
for each RFIC of the plurality of RFICs, the status is determined from a set of status including a preferred status or a non-preferred status.

13. The UE of claim 9, wherein the temperature is a junction temperature of the RFIC.

14. The UE of claim 9, wherein:
to determine, for each RFIC of the plurality of RFICs, the status of the RFIC, the at least one processor is configured to execute the processor-readable code to cause the at least one processor to perform a comparison based on the temperature of the RFIC and a threshold; and
the status is determined based on the comparison.

15. The UE of claim 9, wherein the at least one processor is configured to execute the processor-readable code to cause the at least one processor to:
determine a plurality of consecutive temperatures associated with the RFIC; and
for each pair of consecutive temperatures of the plurality of consecutive temperatures:
determine a change in temperature; and
perform a comparison based on the change in temperature and a threshold; and
wherein the status is determined based on the comparison for each pair of the consecutive temperatures of the plurality of consecutive temperatures.

16. The UE of claim 15, wherein, for each pair of consecutive temperatures of the plurality of consecutive temperatures, a result of the comparison indicates whether the change in temperature is greater than or equal to the threshold.

17. The UE of claim 15, wherein:
the plurality of consecutive temperatures includes multiple pairs of consecutive temperatures, is measured during a time period, or a combination thereof; and
the status is determined based on whether a result of the comparison for each pair of the consecutive temperatures of the plurality of consecutive temperatures indicates that the change in temperature is greater than or equal to the threshold.

18. The UE of claim 9, wherein the at least one processor is configured to execute the processor-readable code to cause the at least one processor to:
determine a first set of RFIC having a first status; and
for each RFIC of the first set of RFICs, determine whether the RFIC is available based on a throughput target, and
wherein the RFIC of the plurality of RFICs is included in the first set of RFICs and selected from the first set of RFICs based on a determination that the RFIC is available.

19. An apparatus configured for wireless communication, the apparatus comprising:
means for determining, for each radio frequency integrated circuit (RFIC) of a plurality of RFICs, a status of the RFIC based on a temperature associated with the RFIC; and
means for selecting an RFIC of the plurality of RFICs based on the plurality of status; and
means for wirelessly communicating data using the selected RFIC.

20. The apparatus of claim 19, further comprising:
means for determining, for each RFIC of the plurality of RFICs, the temperature of the RFIC, and
wherein, for each RFIC of the plurality of RFICs, the status is determined from a set of status including a preferred status or a non-preferred status.

21. The apparatus of claim 19, further comprising:
means for performing, for each RFIC of the plurality of RFICs, a comparison based on the temperature of the RFIC and a threshold, and
the status is determined based on the comparison.

22. The apparatus of claim 19, further comprising:
means for determining a plurality of consecutive temperatures associated with the RFIC; and
means for determining, for each pair of consecutive temperatures of the plurality of consecutive temperatures, a change in temperature; and
means for performing, for each pair of consecutive temperatures of the plurality of consecutive temperatures, a comparison based on the change in temperature and a threshold, and
wherein the status is determined based on the comparison for each pair of the consecutive temperatures of the plurality of consecutive temperatures.

23. The apparatus of claim 22, wherein:
the plurality of consecutive temperatures includes multiple pairs of consecutive temperatures, is measured during a time period, or a combination thereof, and
the status is determined based on whether a result of the comparison for each pair of the consecutive temperatures of the plurality of consecutive temperatures indicates that the change in temperature is greater than or equal to the threshold.

24. The apparatus of claim 19, wherein:
the apparatus further includes:
means for determining a first set of RFIC having a first status; and
means for determining, for each RFIC of the first set of RFICs, whether the RFIC is available based on a throughput target, and
the RFIC of the plurality of RFICs is included in the first set of RFICs and selected from the first set of RFICs based on a determination that the RFIC is available.

25. A non-transitory computer-readable medium storing instructions that, when executed by a processor, cause the processor to perform operations comprising:
for each radio frequency integrated circuit (RFIC) of a plurality of RFICs, determining a status of the RFIC based on a temperature associated with the RFIC;
selecting an RFIC of the plurality of RFICs based on the plurality of status; and
wirelessly communicating data using the selected RFIC.

26. The non-transitory, computer-readable medium of claim 25, wherein the operations further include:
for each RFIC of the plurality of RFICs, determining the temperature of the RFIC, and
wherein, for each RFIC of the plurality of RFICs, the status is determined from a set of status including a preferred status or a non-preferred status.

27. The non-transitory, computer-readable medium of claim 25, wherein:
for each RFIC of the plurality of RFICs, determining the status of the RFIC includes performing a comparison based on the temperature of the RFIC and a threshold, and
the status is determined based on the comparison.

28. The non-transitory, computer-readable medium of claim 25, wherein the operations further include:
determining a plurality of consecutive temperatures associated with the RFIC; and
for each pair of consecutive temperatures of the plurality of consecutive temperatures:
determining a change in temperature; and
performing a comparison based on the change in temperature and a threshold; and
wherein the status is determined based on the comparison for each pair of the consecutive temperatures of the plurality of consecutive temperatures.

29. The non-transitory, computer-readable medium of claim 28, wherein:
the plurality of consecutive temperatures includes multiple pairs of consecutive temperatures, is measured during a time period, or a combination thereof, and
the status is determined based on whether a result of the comparison for each pair of the consecutive temperatures of the plurality of consecutive temperatures indicates that the change in temperature is greater than or equal to the threshold.

30. The non-transitory, computer-readable medium of claim 25, wherein the operations further include:
determining a first set of RFIC having a first status; and
for each RFIC of the first set of RFICs, determining whether the RFIC is available based on a throughput target, and
wherein the RFIC of the plurality of RFICs is included in the first set of RFICs and selected from the first set of RFICs based on a determination that the RFIC is available.
